(19) United States
(12) Patent Application Publication
(10) Pub. No.: US 2014/0158754 A1
(43) Pub. Date: Jun. 12, 2014

(54) ITEM AUTHENTICITY

(71) Applicant: TELEFONAKTIEBOLAGET L M ERICSSON (PUBL), (US)

(72) Inventors: ANNA LARMO, ESPOO (FI); ARI KERANEN, KIRKKONUMMI (FI); DAOYUAN LI, ESPOO (FI); RIIKKA SUSITAIVAL, HELSINKI (FI)

(73) Assignee: TELEFONAKTIEBOLAGET L M ERICSSON (PUBL), STOCKHOLM (SE)

(21) Appl. No.: 13/711,101

(22) Filed: Dec. 11, 2012

(30) Foreign Application Priority Data
Dec. 6, 2012 (EP) PCT/EP2012/074650

(51) Int. Cl. G06Q 99/00

(52) U.S. Cl. CPC G06Q 99/00
USPC 235/375; 235/487

(57) ABSTRACT

This disclosure relates to, among other things, a checking system for checking the authenticity of a product. In some embodiments, the system comprises: a tag, connectable to the product, that comprises an identity parameter of the product; a scanning unit configured for obtaining the identity parameter from the tag; and a database configured for storing a plurality of predetermined identity parameters, wherein the scanning unit sends the obtained identity parameter to the database, and the database compares the received identity parameter with the plurality of predetermined identity parameters stored and sends to the scanning unit information about the authenticity of the product. In this way, a user may obtain information about whether a product is authentic or fake.

### TECHNICAL FIELD

The invention relates to a checking system, configured for checking authenticity of a product.

### BACKGROUND

Fashion industry, artists, and other goods manufacturers typically produce a large number of products that are sold on the market. Usually, valuable items or products and brand goods are labeled in certain ways so that the consumer may distinguish a fake product from a real or authentic one. Nowadays, the industry producing the fake versions or copies is big and international as well. In many cases checking the authenticity of the goods is difficult or even impossible. However, a consumer or a user wants to be sure that they get “the real thing” when they invest a large amount of money to a fashion product or any other product claiming to represent typically a well-known global brand.

As counterfeits are being produced in ever increasing amounts and their quality is becoming better and better, it is more and more difficult for producers or consumers of the authentic products to distinguish the real product from the fake product in order to perceive the differences. Furthermore, the fake products can be even dangerous to the consumers thus harming the original producers' brand. For instance, a fake cell phone battery may explode causing fires or other life threatening situations to the consumers.

### SUMMARY

It is the object of the invention to provide a possibility for a user, such as a producer or a consumer, to check whether a product is authentic or fake while being reliable and easy to realize.

This object is achieved by the subject matter of the independent claims. Preferred embodiments are defined in the sub claims.

According to a first aspect of the invention, this object is achieved by a checking system, configured for checking authenticity of a product, comprising a tag configured for being connectable to the product, wherein the tag comprises at least one identity parameter of the product, a scanning unit configured for scanning the tag, wherein the scanning unit requests the tag for at least one identity parameter of the product, and a database configured for storing a plurality of predetermined identity parameters, wherein the scanning unit sends the at least one identity parameter to the database, and wherein the database compares the at least one identity parameter received with the plurality of predetermined identity parameters stored and sends the scanning unit an information about the authenticity of the product.

It is an idea of the invention to provide a tag that is connectable to the product, wherein connectable preferably comprises a mechanical connection, i.e. connectable corresponds to attachable, and/or an electronic connection. A simple electronic or even a non-electronic tag is connectable to the product in order to ensure the authenticity of the product. The buyer is thus able to simply scan the tag, for instance via a mobile phone, and so check the authenticity of the product online Furthermore, the tag can be used to log history of vintage products, for instance, the tag on an expensive vintage designer dress could tell that the dress was owned by a member of a royal family or by a celebrity.

According to a preferred embodiment of the invention, the plurality of predetermined identity parameters comprises at least an information about when and/or where the manufacturing of the product has occurred, an information about history of the product and/or a verifying stamp configured for ensuring authenticity of the product.

According to a preferred embodiment of the invention, the tag comprises an electronic circuitry, such as a radio-frequency identification chip, RFID chip for short. Hence, no energy source, i.e. no battery is needed. A tag is thus integrated into a passive RFID chip and thus is washable and endurable to different environmental conditions.

According to a preferred embodiment of the invention, the tag is further configured for being encryptable with a predefined code and/or for being integrated into the product. Hence, the tag does not have a significant impact on the appearance of the product since it can be integrated into a part of the product such that it is not easy recognizable at a first glance by a user. Further, any mathematical coding technologies can be easily applied to the tag. The tag is preferably further configured for logging in history of the product, such as a vintage product.

According to a preferred embodiment of the invention, the scanning unit corresponds to glasses, to a phone, to a Smartphone or to a wireless device, such as a tablet computer or a laptop. Preferably, the scanning unit is configured for having internet access and corresponds to glasses, such as to Google or to Microsoft glasses. The scanning unit preferably comprises an application unit configured for running an application that is configured for scanning at least partly the product. By scanning the product it is easily possible to obtain information about predetermined identity parameters of the product. Preferably, the scanning unit while sending the at least one identity parameter to the database and receiving the information about the authenticity of the product from the database is configured for communication via an Internet protocol. Hence, with the invention at hand it is possible to use also existing Internet technologies very reliable.

According to a preferred embodiment of the invention, the database is configured for comparing the at least one identity parameter received with information stored in a look-up table. The database is preferably arranged on a server and is further configured for cloud-computing. Hence, the checking system is easily to be used with existing and future technologies such as with cloud-computing which is based on sharing of resources, where for instance a user uses cloud-computing by using network client devices, such as desktop computers, laptops, tablets and/or Smartphones.

According to a preferred embodiment of the invention, the database is configured for sending an information about the authenticity of the product corresponding to at least one out of the plurality of predetermined identity parameters and the scanning unit further comprises a display unit that is configured for displaying the information received such that a user identifies whether a product is authentic or fake.

According to a second aspect of the invention, above mentioned object is achieved by a device, configured for verifying authenticity of a product, comprising a product and a tag, wherein the tag is configured for being connectable to the product and comprises at least one identity parameter of the product, and wherein the tag is further configured for obtaining information about the product such that the authenticity of the product is verified. It is noted that the term “obtaining information about the product” preferably corresponds to receiving information about the product from other devices, units and/or apparatuses or also to sending information about the product towards other devices, units and/or apparatuses.

According to a third aspect of the invention, above mentioned object is achieved by a method for checking authenticity of a product, comprising the steps of a) scanning for at least one identity parameter of the product, b) sending the at least one identity parameter to a database, and c) comparing the at least one identity parameter received with a plurality of predetermined identity parameters stored in the database such that an information about the authenticity of the product is obtained.

Hence, it is an idea of the invention to generate a channel for the original producer of a good to tell the consumer whether the consumer is buying the original, actual or authentic product or a fake version or copy of the original product, respectively. Hence, with the invention at hand the counterfeit industry is fought.

### BRIEF DESCRIPTION OF THE DRAWINGS

Further objects and advantages of the present invention will become apparent from the following description of the preferred embodiments that are given by way of example with reference to the accompanying drawings. In the figures:

FIG. 1 shows a checking system configured for checking authenticity of a product according to a first preferred embodiment of the invention;

FIG. 2 schematically illustrates the steps of a method for checking authenticity of a product according to a second preferred embodiment of the invention; and

FIG. 3 shows a device configured for verifying authenticity of a product according to a third preferred embodiment of the invention.

### DETAILED DESCRIPTION

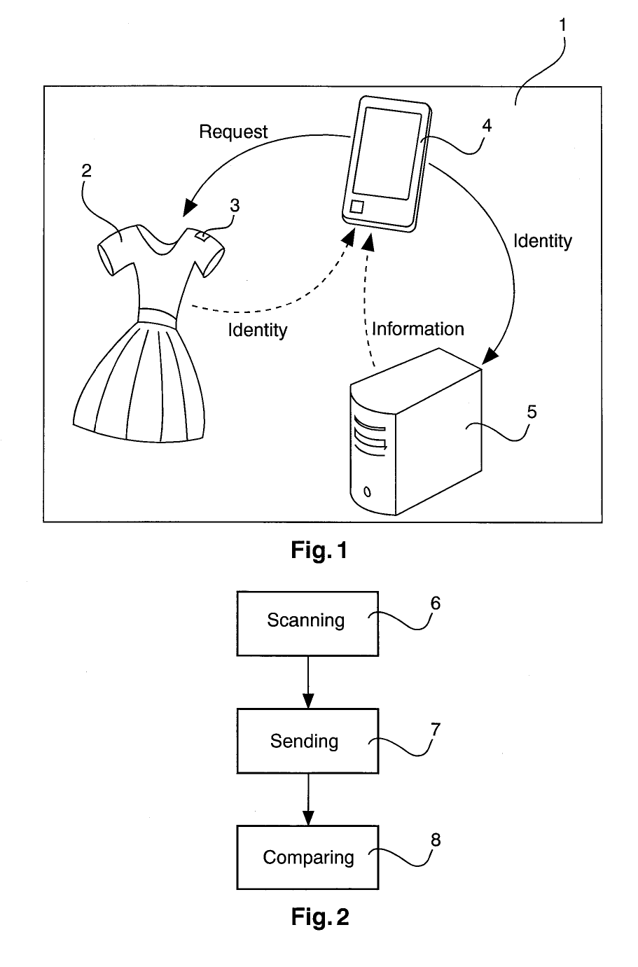

FIG. 1 shows a checking system according to a first preferred embodiment of the invention. The checking system 1 comprises a scanning unit 4, a database 5 and a tag 3 which is mechanically connected, i.e. attached, to the product 2 that is a lady's dress in this preferred embodiment. An application unit comprised by the scanning unit 4 scans the tag 3 and thus requests an identity parameter showing where and when the dress has been manufactured. This information is sent to the database 5 which compares this information with information stored in a look-up table and subsequently sends the information about the authenticity of the dress to the scanning unit 4 which is then displayed on a display unit that is also comprised by the scanning unit 4. In this first preferred embodiment of the invention the tag 3 is unique and visible. According to other preferred embodiments of the invention, a tag is encrypted by means of coding algorithms and/or not visible to a user or any other observer. In this first preferred embodiment of the invention the scanning unit 4 further comprises, next to the display unit, which is realized as a screen, and the application unit, a power source. It acts fast and communicates via an Internet protocol with the database 5. The database 5 is arranged somewhere far away on a server belonging to a service provider in this preferred embodiment of the invention. The provider is responsible for updating the information stored in the database 5 such that the information about the authenticity of a product is always up-to-date. The database 5 is further configured for storing a request for an identification, ID for short, and for checking the validity of the request via the received user ID. According to other preferred embodiments of the invention, the database 5 is further configured for using information from previous scans received from the scanning unit 4.

FIG. 2 schematically illustrates the steps of a method for checking authenticity of a product according to a second preferred embodiment of the invention. In a first step, it is scanned 6 for at least one identity parameter of a product. In a second step, the at least one identity parameter is sent 7 to a database before, in a final step, it will be compared 8 with a plurality of predetermined identity parameters stored in the database such that an information about the authenticity of the product is obtained. The method can be performed on any kind of platforms.

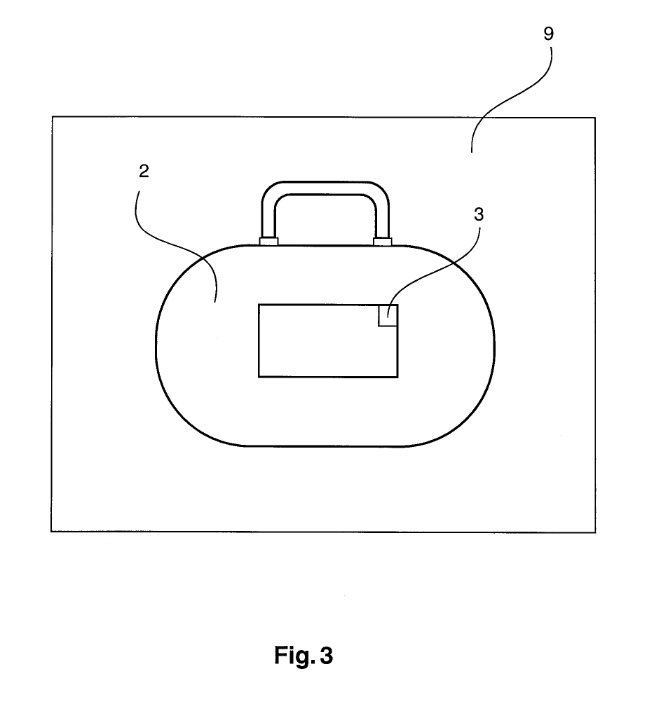

FIG. 3 shows a device 9 configured for verifying authenticity of a product according to a third preferred embodiment of the invention. The device 9 comprises a product 2 and a tag 3. The tag 3 is mechanically connected to the product 2 and provides one identity parameter of the product 2. In this preferred embodiment the ID number of the product is used as identity parameter. The device 9 is adapted for receiving information about the product from and/or for sending information about the product towards other devices. In this preferred embodiment, the tag 3 obtains information about the product 2 and thus the authenticity of the product 2 is verified. According to yet other preferred embodiments of the invention, the information about the product comprises a plurality of predetermined identity parameters comprising at least an information about when and/or where the manufacturing of the product has occurred, an information about history of the product, a verifying stamp configured for ensuring authenticity of the product, a trademark of the product and/or a label of the product.

While the invention has been illustrated and described in detail in the drawings and foregoing description, such illustration and description are to be considered illustrative or exemplarily and not restrictive; the invention is not limited to the disclosed embodiments.

Other variations to the disclosed embodiments can be understood and affected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that the combination of these measures cannot be used to advantage. Any reference signs in the claims should not be construed as limiting the scope.

1. A checking system, configured for checking authenticity of a product, comprising:
a tag configured for being connectable to the product, wherein the tag comprises an identity parameter of the product;
a scanning unit configured for obtaining from the tag the identity parameter; and
a database configured for storing a plurality of predetermined identity parameters, wherein
the scanning unit is configured to send to the database the obtained identity parameter, and
the database is configured to (i) use the identity parameter received from the scanning to obtain information about the authenticity of the product and (ii) send to the scanning unit said information about the authenticity of the product.

2. The checking system according to claim 1, wherein the plurality of predetermined identity parameters comprises an (i) information about when and/or where the manufacturing of the product has occurred, (ii) information about the product's history, and/or (iii) a verifying stamp configured for ensuring authenticity of the product.

3. The checking system according to claim 1, wherein the tag comprises an electronic circuit.

4. The checking system according to claim 1, wherein the tag is further configured for being encryptable with a predefined code and/or for being integrated into the product.

5. The checking system according to claim 1, wherein the tag is further configured for logging in history of the product.

6. The checking system according to claim 1, wherein the scanning unit corresponds to glasses, to a phone, to a Smartphone or to a wireless device.

7. The checking system according to claim 6, wherein the scanning unit is configured for having internet access and corresponds to glasses.

8. The checking system according to claim 1, wherein the scanning unit comprises an application unit configured for running an application that is configured for scanning at least partly the product.

9. The checking system according to claim 1, wherein the scanning unit while sending the at least one identity parameter to the database and receiving the information about the authenticity of the product from the database is configured for communication via an Internet protocol.

10. The checking system according to claim 1, wherein the database is configured for comparing the at least one identity parameter received with information stored in a look-up table.

11. The checking system according to claim 1, wherein the database is arranged on a server and is further configured for cloud-computing.

12. The checking system according to claim 1, wherein the database is configured for sending an information about the authenticity of the product corresponding to at least one out of the plurality of predetermined identity parameters and the scanning unit further comprises a display unit that is configured for displaying the information received such that a user identifies whether the product is authentic or fake.

13. A device, configured for verifying authenticity of a product, comprising:
a product; and
a tag, wherein
the tag is configured for being connectable to the product and comprises an identity parameter of the product, and
the tag is further configured for obtaining information verifying the authenticity of the product.

14. A method for checking authenticity of a product, comprising the steps of:
a) scanning for at least one identity parameter of the product,
b) sending the at least one identity parameter to a database, wherein the database is configured to use the at least one identity parameter to obtain information about the authenticity of the product, and
c) receiving from the database said information about the authenticity of the Product.

15. A method for providing information to a shopper regarding the authenticity of a product, comprising:
storing a product identifier in a database;
receiving from a scanner a product identifier for identifying the product;
determining whether the received product identifier matches the stored product identifier;
in response to determining that the received product identifier matches the stored product identifier, sending to the scanner a message comprising information indicating that the product is an authentic product.
